(19) United States
(12) Patent Application Publication
(10) Pub. No.: US 2005/0158517 A1
(43) Pub. Date: Jul. 21, 2005

(54) Corrugated foam/film laminates for use as floor underlayment

(75) Inventors: David Rives, Grapevine, TX (US); Natarajan S. Ramesh, Grapevine, TX (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sealed Air Corporation (US), Saddle Brook, NJ (US)

(21) Appl. No.: 10/758,402

(22) Filed: Jan. 15, 2004

(51) Int. Cl. B32B 3/12; B32B 3/26; B32B 3/28; B32B 3/30

(52) U.S. Cl. 428/158; 428/167; 428/159

(57) ABSTRACT

A laminate for use as a floor underlayment material includes a film disposed on at least one surface of an expanded foam web. The foam web includes a plurality of ribs projecting from one surface of the web in a length direction thereof so as to define a corrugated surface. The film is disposed on the surface of the foam web opposite the corrugated surface. The film is preferably formed from a high density polymer so as to enhance the moisture barrier properties of the laminate. When installed between a subfloor and finish flooring, the laminate defines channels which enable moisture emanating from the subfloor to be directed out from the flooring system.

### BACKGROUND OF THE INVENTION

The present invention relates to expandable foams, and more particularly to expandable foams for use as a floor underlayment. Still more particularly, the present invention is directed to laminates of a film and an expandable foam useful as a floor underlayment.

Flooring systems in residential and commercial buildings typically consist of wood or steel joists supporting a subfloor and finish flooring. In single-family and multi-family homes and small commercial buildings, the subfloor is often formed from wooden boards or panels laid over the joists. In apartment buildings, larger commercial buildings and other steel-frame buildings, the subfloor may be a steel deck, precast concrete slabs or panels, or poured concrete.

The finish flooring is installed over the subfloor and provides a decorative, aesthetically pleasing floor surface. The finish flooring may be wood, such as wood planks, parquet flooring and wood-block flooring, or a resilient material, such as linoleum, asphalt tile, or vinyl or rubber tile or sheet.

In buildings having concrete subfloors, it is known to install a thin layer of polyethylene film and a layer of polyethylene foam, or a polyethylene film/foam laminate, as an underlayment between the concrete subfloor and finish flooring formed of wood. The underlayment levels small irregularities in the top surface of the concrete, provides a small degree of resiliency to the floor system, and provides a vapor barrier to prevent moisture emanating from the concrete subfloor from attacking and deteriorating the finish flooring.

Despite the advantages provided by the existant floor underlayments, they act to trap any moisture which may be present in the concrete subfloor and prevent its escape. This may result in the development of mold, fungus and other growths, leading to odors and other health concerns. In addition, because of the tendency of these underlayments to trap moisture, they are not usable with wood subfloors which would deteriorate on prolonged exposure to moisture. Accordingly, there exists a need for an improved floor underlayment which provides the cushioning, vapor barrier and floor leveling functions of the prior floor underlayments, but which also permits the escape of moisture from the subfloor so as to avoid the disadvantages associated therewith.

### SUMMARY OF THE INVENTION

The present invention addresses these needs.

According to one aspect of the present invention, a floor underlayment material includes a foam web including a polymer matrix and a multiplicity of voids dispersed throughout the polymer matrix. The foam web extends in a length direction and has first and second surfaces, with a plurality of spaced ribs projecting from the first surface and oriented in the length direction. A film is disposed on the second surface of the foam web. Preferably, the film is formed from a polymer; more preferably from a polyolefin. Films for use in the present invention desirably have a thickness between about 0.25 mils and about 20 mils. Such films may include one or more additives selected from the group consisting of antioxidants, anti-corrosion agents, anti-bacterial agents, anti-microbial agents, anti-fungal agents, anti-static agents, UV stabilizers, fire retardants, fire resistants and biostabilizers.

The polymer matrix in the foam web may be formed from substantially the same polymer as the film. More preferably, both the film and the polymer matrix in the foam web may be formed from polyethylene.

The foam web has a predetermined thickness between the first and second surfaces, and the ribs project from the first surface by a height dimension. Preferably, the height dimension is greater than the predetermined thickness of the web, and more preferably at least about twice as large as the predetermined thickness. The thickness of the foam web between the first and second surface may be between about 0.01 inches and about 1.50 inches. The overall thickness of the foam web, including the predetermined thickness and the height dimension, may be between about 0.02 inches and about 4 inches. Each of the ribs may be separated from an adjacent rib by any amount, but preferably by at least the width of the ribs at their junction with the first surface. The ribs may have a generally triangular cross-sectional shape, and may extend continuously or discontinuously in the length direction.

Desirably, the foam web has a density between about 0.5 lb/ft³ and about 15 lb/ft³. More desirably, the foam web has a density of less than about 10 lb/ft³. The foam web may include one or more additives selected from the group consisting of antioxidants, colorants, anti-corrosion agents, anti-bacterial agents, anti-microbial agents, anti-fungal agents, anti-static agents, UV stabilizers, fire retardants, fire resistants, fillers, reinforcements, biostabilizers and pigments.

Another aspect of the present invention provides a flooring system, including a subfloor; finish flooring arranged above the subfloor; and a floor underlayment material disposed between the subfloor and the finish flooring. The floor underlayment material includes a foam web including a polymer matrix and a multiplicity of voids dispersed throughout the polymer matrix. The foam web extends in a length direction and has first and second surfaces and a plurality of spaced ribs projecting from the first surface and oriented in the length direction. A film is disposed on the second surface of the foam web. The floor underlayment material may be positioned with the film disposed adjacent the subfloor so that the ribs face toward the finish flooring, thereby defining a multiplicity of elongated channels between the finish flooring and the floor underlayment material. Alternatively, the floor underlayment material may be positioned with the film disposed adjacent the finish flooring so that the ribs face toward the subfloor, thereby defining a multiplicity of elongated channels between the subfloor and the floor underlayment material.

### BRIEF DESCRIPTION OF THE DRAWINGS

A more complete appreciation of the subject matter of the present invention and the various advantages thereof can be realized by reference of the following detailed description in which reference is made to the accompanying drawings, in which:

FIG. 1 is a highly schematic view showing a process for forming an expanded foam web in accordance with the present invention;

FIG. 2 is a highly schematic view showing a process for laminating a film to the expanded foam web;

FIG. 3 is a highly schematic cross-sectional view of a film/foam laminate according to the present invention;

FIG. 4 is a highly schematic cross-sectional view of a film/foam laminate according to an alternate embodiment of the present invention;

FIG. 5 is a highly schematic cross-sectional view of a flooring system incorporating the film/foam laminate of FIG. 3; and

FIG. 6 is a highly schematic cross-sectional view of an alternate flooring system incorporating the film/foam laminate of FIG. 3.

### DETAILED DESCRIPTION

Preferred processes for forming film/expanded foam laminates according to the present invention generally include the steps of (1) providing a mass of a polymer in a flowable state; (2) incorporating a blowing agent in the polymer mass; (3) forming the polymer/blowing agent mixture to a desired corrugated shape; (4) expanding the blowing agent to form a corrugated foam structure consisting of a phase of pores or cells dispersed throughout a polymer matrix; (5) solidifying the foam structure; and (6) adhering a film to the non-corrugated side of the foam structure. Polymers, additives and blowing agents useful in the present invention, as well as methods for combining these materials and forming same into expanded foam structures, are well known in the art and include those disclosed in commonly assigned U.S. Pat. Nos. 5,667,728 and 6,030,696, the disclosures of which are hereby incorporated by reference herein. In the expanded foam structures for use in the present invention, greater than about 50 percent of the cells preferably are closed. In use, such closed cell foam structures will provide a degree of resiliency to the flooring system, but will not collapse or lose substantial thickness if a normal load is applied to an overlying floor. As a result, such structures will better maintain their corrugated shape and their ability to channel moisture and other vapors away from the subfloor.

The polymers which may be used to form the expanded foam portion of the present invention include any foamable thermoplastic or thermosetting materials, including blends of two or more thermoplastic materials, blends of two or more thermosetting materials, or blends of thermoplastic materials with thermosetting materials. Suitable polymers include polystyrene, polyolefins, polyurethanes, polyesters including polyethylene terephthalate, and polyisocyanurates, with polyolefins being particularly preferred. Polyolefins are thermoplastic polymers derived from unsaturated hydrocarbons containing the ethylene or diene functional groups. Although the polyolefins may include virtually all of the addition polymers, the term “polyolefin” ordinarily refers to polymers of ethylene, the alkyl derivatives of ethylene (the alphaolefins), and the dienes. Among the more commercially important polyolefins are polyethylene, polypropylene, polybutene, and their copolymers, including ethylene/alpha-olefin copolymers such as linear low density polyethylene, and blends of the foregoing materials. Polyethylene is particularly useful in the practice of the present invention.

Polyethylene is a whitish, translucent polymer of moderate strength and high toughness which is available in varieties ranging in crystallinity from 20 to 95 percent, and in ultra low, low, medium and high density polymer forms. The low density material has a softening temperature between about 95° C. and about 115° C., while the high density material has a softening temperature between about 130° C. and about 140° C. Low, medium and high density polyethylenes and mixtures thereof are suitable for extrusion forming.

The present invention may utilize any of the known blowing agents, including fluorocarbons; hydrofluorocarbons; chlorofluorocarbons; hydrochlorofluorocarbons; alkylhalides, such as methyl chloride and ethyl chloride; and hydrocarbons. Other suitable blowing agents may include pristine blowing agents such as air, carbon dioxide, nitrogen, argon, water and the like. The blowing agent may consist of a mixture of two or more of any of the blowing agents set forth above. Other suitable blowing agents may also include chemical blowing agents such as ammonium and azotype compounds, including ammonium carbonate, ammonium bicarbonate, potassium bicarbonate, diazoaminobenzene, diazoaminotolulene, azodicarbonamide, diazoisobutyronitrile, and the like.

Preferred blowing agents in accordance with the present invention are hydrocarbons, including normal butane, isobutane, pentane, isopentane, hexane, isohexane, heptane, propane and the like, including combinations of two or more of these materials. Particularly preferred blowing agents for use with polyethylene are propane, normal butane, isobutane and mixtures thereof.

In addition to the polymer and the blowing agent, the mixtures for forming the foam structures of the present invention may include one or more additives for enhancing the properties of the foam and the forming process. For example, elastomeric components such as polyisobutylene, polybutadene, ethylene/propylene copolymers, and ethylene/propylene diene interpolymers may be incorporated in the mixture. Other potential additives include cross-linking agents, extrusion aides, antioxidants, colorants, UV stabilizers, fire retardants, fire resistants, anti-microbial agents, anti-fungal agents, anti-corrosion agents, anti-bacterial agents, anti-static agents, fillers, reinforcements, fiber reinforcements, biostabilizers, pigments, etc. as desired, all of which are conventional in the art.

The mixture may also include one or more permeability modifiers for controlling the replacement of the blowing agent in the cells of the foam with air while preventing substantial shrinkage of the foam structure from premature excessive loss of the blowing agent. Suitable permeability modifiers include fatty acid esters and amides such as glycerol monostearate and stearyl stearamide. The permeability modifier is used in an amount sufficient to produce a desirable rate of exchange of air for blowing agent in the cells of the foam. This amount is generally dictated by the polymer matrix material, the blowing agent composition and quantity, processing conditions, etc. For mixtures in which the polymer is polyethylene and the blowing agent is isobutane, a permeability modifier consisting of a 2:1 mixture of glycerol monostearate in monoethanolamide may be mixed with the polyethylene, preferably prior to melting, in an amount from about 0.3 to about 5 percent by weight of the polyethylene. Glycerol monostearate/monoethanolamide additions of about 0.3 to about 2.0 percent by weight of the polyethylene are preferred. On the other hand, where the polymer is polypropylene, permeability modifiers are not typically needed, but may be used in appropriate quantities to reduce friction-induced static in the polymer and foams.

A nucleation agent may also be added to the mixture to promote nucleation and to control cell development and size. Preferred nucleating agents include low activity metal oxides, such as zinc oxide, zirconium oxide and talc; sodium bicarbonate/citric acid blends, such as those available under the trademark Hydrocerol from Clariant Corporation of Winchester, Va.; and other materials known in the art. The amount of nucleating agent added to the mixture will depend upon the composition and activity of the nucleating agent, the composition of the polymer matrix material, the blowing agent composition and quantity, and processing conditions, as well as upon the pore size and pore density desired in the expanded foam. Sodium bicarbonate/citric acid nucleating agents preferably are added in an amount from about 0 to 1.5 percent by weight of the polymer. For polyethylene/isobutane mixtures, additions of such nucleating agents in amounts between about 0.05 and 1.0 percent by weight of polyethylene are preferred. Talc, which is less active, is preferably added as a nucleating agent in an amount of from about 0 to 2 percent by weight of the polymer, with additions of between about 0.2 and 1.0 percent by weight of polyethylene being preferred in polyethylene/isobutane mixtures.

Once the polymer and additives have been selected, these materials are mixed together to form a mixture. This may be accomplished in a conventional batch mixing step. Alternatively, where the foam structures are to be formed by extrusion, pellets of a thermoplastic polymer may be placed in the hopper of an extruder. Any nucleating agents, permeability modifiers and/or other additives may be added to the hopper and combined in a solid state with the polymer pellets to form a homogenous mixture. Intimate mixing of these components is important to assure uniform pore distribution throughout the extruded foam as well as uniform blowing agent dissipation from the expanded foam. The solid mixture may then be conveyed to the melt zone of the extruder in which the mixture is thoroughly melted. The mixture should be brought to a high enough temperature above its melting point to have sufficient fluidity for mixing with the blowing agent. Temperatures which are between about 20° C. and about 100° C. above the melting point of the polymer are preferred. The melt zone may be maintained at a somewhat lower temperature due to the heat that is generated by friction as the melted mixture flows through the extruder.

The melted mixture may then be metered to a mixing zone where it is mixed with the blowing agent under pressure. The blowing agent typically is injected between the metering and mixing zones, and through either a single port or multiple ports, using high pressure pumps. Where the blowing agent includes more than one component, the components may be injected separately through multiple ports or in combination through a single port. When injected, the blowing agent initially forms a dispersion of insoluble bubbles within the melted thermoplastic mass. These bubbles eventually dissolve in the thermoplastic mass as the mixing continues and the pressure increases down the length of the extruder. Desirably, the extruder has a length to diameter ratio of at least 30:1 and a mixing zone with a sufficient length to ensure that a homogenous mixture is formed. In this regard, single screw extruders may be used in processes according to the present invention, although double screw extruders may be used for greater mixing. Double screw extruders may be either twin screw, in which the mixture passes through two screws arranged parallel to one another, or tandem screw, in which the mixture passes through two screws arranged in series.

The blowing agent generally is added to the molten polymer in amounts of between about 3 and about 20 percent by weight of the polymer. For polyethylene/isobutane mixtures, the butane preferably is added in amounts of between about 5 and about 15 percent by weight of the polyethylene, depending on the thickness of the foam. Where higher density foams are desired, lesser amounts of blowing agent are typically added. Thus, the minimum and maximum useful proportions of blowing agent in the molten mass are density related. The quantity of blowing agent also is related to the pressure that is maintained on the molten polymer/blowing agent mixture in the extrusion die passage.

After mixing, the temperature of the polymer/blowing agent mixture should be lowered to a temperature which is closer to its melting point so that the blowing agent does not readily escape from the polymer upon expansion, thereby enabling the polymer to maintain its structure upon foaming. However, overcooling of the mixture may hinder complete expansion of the foam, and therefore should be avoided. The blowing agent has a plasticizing effect on the polymer mixture, reducing its viscosity or resistance to flow, and so the melting point of the polymer/blowing agent mixture ordinarily is below that of the polymer alone. The expansion temperature, which is above the melting point of the polymer/blowing agent mixture, may be empirically determined and depends upon the composition of the polymer, the length of the extruder screw, whether single or double screws are used, and on the composition and amount of the blowing agent. For a low density polyethylene, the expansion temperature generally will be in the range of between about 85° C. and about 120° C.

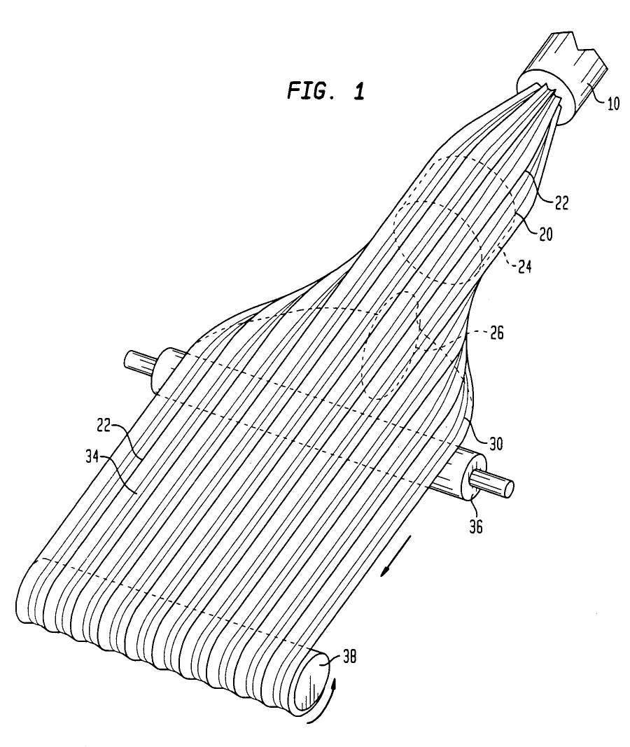

FIG. 1 is a highly schematic diagram illustrating the extrusion process and subsequent steps for forming an expanded foam web. When cooled to the appropriate temperature, the polymer/blowing agent mixture may be extruded through a die 10 having an appropriate shape. For making corrugated foam webs for use in the present invention, a die having an annular shape for extruding a foam tube is preferred. The annular die preferably has an inner fixture with a smooth circular surface, and an outer fixture formed with regularly spaced notches having dimensions suitable to form ribs of a desired width and depth projecting from the extruded foam structure. As used herein, foam webs that are “corrugated” are those in which at least one surface of the web has a series of alternating peaks and valleys which extend in the length or width direction of the web.

Within die 10, the polymer/blowing agent mixture is under high pressure which prevents the foam from expanding. As it exits the die, however, the mixture is exposed to a low pressure environment, such as atmospheric pressure. This sudden drop in pressure causes bubble nucleation and expansion or foaming of the structure. As it exits annular die 10, the mixture may be extruded into a tubular-shaped expanded foam structure 20 having a smooth circular inner circumference and an outer circumference formed with a series of spaced ribs 22. The tubular-shaped structure may then be passed over a water-cooled can 24 which cools and solidifies the expanded foam. As it leaves the cooling can 24, the tubular foam structure 20 is slit longitudinally by a rotary knife 26 and opened to form a web 30 having a substantially flat surface 32 on one side thereof and a surface 34 on the other side thereof with ribs 22 projecting therefrom to thereby define a corrugated surface. Web 30 may be cast over a water-cooled ring or roller 36 with surface 32 in contact with the ring so as to cool the structure further, and then advanced to a winder 38 where it is wound into rolls. The foam web 30 may be cured for two to three days or other time sufficient for the blowing agent to diffuse out of the structure and air to diffuse into the structure. It will be appreciated that the present invention is not limited to the technique described above for forming foam web 30, but that other available techniques are contemplated herein. For example, rather than an annular die, the polymer/blowing agent mixture may be extruded through a die having the cross-sectional shape of foam web 30, thereby eliminating the need for the slitting and flattening steps described above.

Generally, foam webs 30 for use in the present invention have a thickness between surfaces 32 and 34 (i.e., not including the height of ribs 22) of between about 0.01 inches and about 1.50 inches, depending upon the material from which the web is formed. Further, the width of foam web 30 is limited only by manufacturing capabilities and shipping, handling and installation considerations.

The foam webs 30 for use in the present invention may have a density between about 0.50 lb/ft³ and about 15 lb/ft³. Most preferred are foam webs having a density of less than about 10 lb/ft³. Lower densities of foam webs result from a higher volume of pores dispersed therein.

Once the foam structure has sufficiently cured, a polymer film 50 may be laminated to the flat side 32 of the web. Film 50 may be formed from any material having moisture barrier properties. Preferably, film 50 is formed from a polymer, with polyolefin polymers being particularly preferred. Suitable polyolefins for use as film 50 include LLDPE, low density polyethylene, high density polyethylene, metallocene catalyzed polyethylene, polypropylene, and oriented polypropylene. Film 50 may have a single layer construction, or may be formed from multiple layers for improved moisture barrier properties. Preferred films for use in the present invention have a thickness between about 0.25 mil and about 20 mil. Film 50 may be formed from substantially the same polymer as is used to form foam web 30, or from a different polymer which is easily adhered to foam web 30. In preferred embodiments, however, foam web 30 may be formed from a low density form of a polymer, while film 50 may be formed from a high density form of the same polymer. As with foam web 30, film 50 may include one or more additives, such as antioxidants, anti-corrosion agents, UV stabilizers, fire retardants, fire resistants, anti-bacterial agents, anti-microbial agents, anti-fungal agents, anti-static agents, biostabilizers and/or other functional additives depending on the commercial application of the laminate.

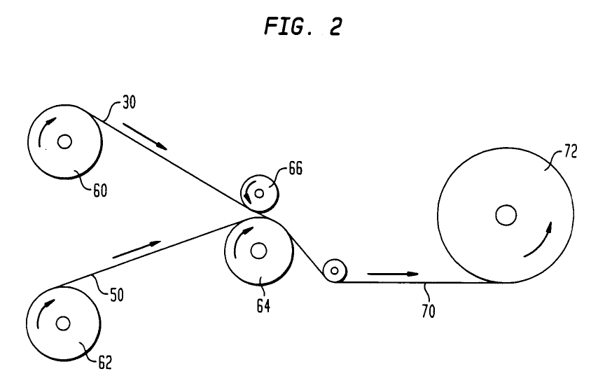

The lamination of film 50 to foam web 30 may be accomplished by any known technique, including the application of an adhesive, including molten polymer, between film 50 and foam web 30; ultrasonic welding techniques; thermal welding techniques; and the like. A particularly preferred technique is a conventional heat lamination process shown schematically in FIG. 2. In such process, foam web 30 and film 50 are fed from rollers 60 and 62, respectively, with the flat surface 32 of the foam web confronting film 50. The materials come together at a heated roller 64 which heats film 50 to a temperature sufficient to tackify the film, or at least the layer of the film confronting foam web 30. The heated film 50 and foam web 30 then pass through a nip formed between heated roller 64 and a nip roller 66 which presses the materials together, whereupon film 50 adheres to the foam web. More particularly, the film 50 adheres to the flat surface 32 of foam web 30, thereby creating a film/foam laminate 70 which is accumulated on a take-up roller 72.

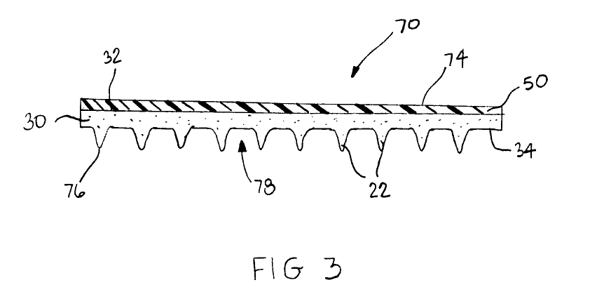

A film/foam laminate 70 in accordance with the present invention is illustrated in FIG. 3. Laminate 70 has a top surface 74 defined by film 50, and a bottom surface 76 defined by the free ends of ribs 22 projecting from surface 34 of foam web 30. Ribs 22 extend in the length direction of laminate 70 so that a channel 78 is formed between each adjacent pair of ribs 22.

As will be appreciated, the height and spacing of ribs 22 will determine the width and height dimensions of channels 78. Generally speaking, laminates 70 in which channels 78 have larger volumes will have superior moisture channeling properties than laminates 70 in which channels 78 have smaller volumes. While ribs 22 may be separated from one another by any amount, in preferred arrangements, ribs 22 are spaced sufficiently close together so as to support laminate 70 and any finish flooring installed over laminate 70, including any articles placed on the finish flooring. In highly preferred arrangements, ribs 22 are spaced so that the distance between the free edges of adjacent ribs 22 is at least as great as the width of each rib 22 where it meets surface 34 of foam web 30.

Ribs 22 preferably have a height which is greater than the thickness of foam web 30 between surfaces 32 and 34. More preferred are ribs 22 which have a height which is at least about twice as large as the thickness of foam web 30 between surfaces 32 and 34. In that regard, the overall thickness of foam web 30, inclusive of ribs 22, preferably is between about 0.02 inches and about 4 inches.

Although ribs 22 are depicted in FIG. 3 as having a generally triangular cross-sectional shape, that need not be the case. That is, ribs 22 may be formed with any geometry capable of supporting laminate 70 so as to maintain channels 78 during use of the laminate. Thus, ribs 22 may have cross-sectional shapes which are rectangular, semicircular, etc. Moreover, all of the ribs 22 in foam web 30 may be uniform in shape and size, or some of the ribs may have a different shape or size from others of the ribs. Furthermore, ribs 22 need not be continuous along the entire length of foam web 30. Thus, there may be applications in which it is desirable for at least some of the ribs 22 to be discontinuous, with periodic or random breaks defining passageways connecting adjacent channels 78.

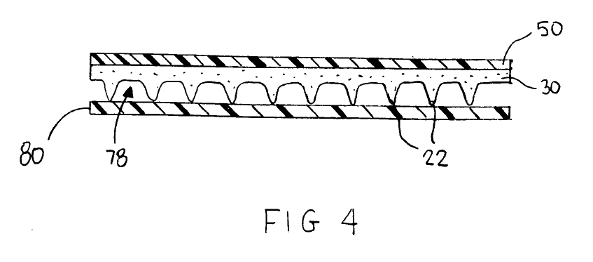

Optionally, film/foam laminate 70 may have a second film 80 laminated to the corrugated side of the web, i.e., to the free edges of ribs 22, as shown in FIG. 4. Film 80 may be formed from the same material as film 50, or may be formed from any material which will provide a particularly desirable property to the laminate. For example, laminate 70 may include a second high density polyethylene film laminated to the free edges of ribs 22. Laminates including this additional film layer may be desirable, for example, in situations in which a superior moisture barrier or increased toughness is needed. Film 80 may be laminated to the free edges of ribs 22 by repeating the technique described above for laminating film 50 to foam web 30, or by any other known technique, including those noted above. Alternatively, by replacing nip roller 66 with a heated roller, films 50 and 80 may be laminated to foam web 30 simultaneously in a single process.

In a variant of the present invention, the foam web may be formed with two corrugated surfaces, that is, with ribs 22 protruding both from surface 34 and from surface 32. The ribs 22 protruding from surface 32 may have the same or different dimensions than the ribs 22 protruding from surface 34. Such foam structures may be formed directly by an appropriately shaped extrusion die, or an equivalent structure may be formed by adhering two foam webs 30 to one another in back to back relationship. Each side of the foam web may then have the same or different films 50 laminated to the free edges of the ribs, forming a laminate having a central foam web and enclosed channels 78 extending longitudinally on both sides thereof. Alternatively, two laminates 70 as shown in FIG. 3 may be adhered to one another in back to back relationship so as to form a structure having two foam webs 30 sandwiching two layers of film 50. Variants of the foregoing structures are also contemplated herein, including structures in which one or more layers of film 50 are sandwiched between foam webs 30, with or without films _ adhered to the free edges of ribs 22.

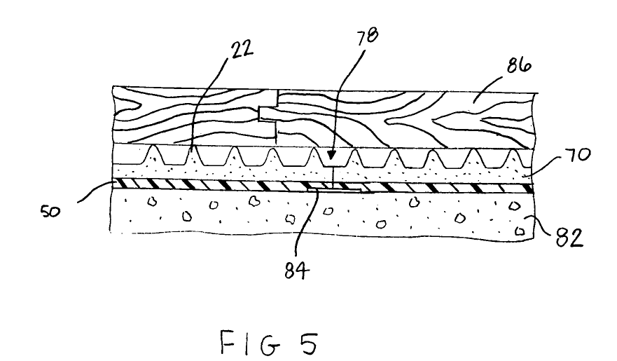

Laminate 70 may be used as an underlayment between the subfloor and the finish flooring of a flooring system. An example of one such flooring system in which laminate 70 is installed between a concrete subfloor and wood laminate finish flooring is illustrated in FIG. 5. Laminate 70 ordinarily is positioned freely (i.e., using no adhesive or other attachment mechanism) on concrete subfloor 82 so that film 50 contacts the concrete subfloor and ribs 22 face away from the subfloor. Webs of laminate 70 are installed so that the side edges of adjacent webs butt up against one another. During installation, adjacent webs of laminate 70 may be joined together by a strip of tape 84. Planks 86 of laminate wood flooring may be positioned on laminate 70 in a free-floating manner so that the planks rest on the free edges of ribs 22. Adjacent planks 86 may be glued or otherwise joined together using a conventional tongue-in-groove arrangement, but the planks are not adhered to laminate 70.

In the installed position of the laminate, channels 78 confront planks 86, while film 50 serves as a vapor barrier between foam web 30 and subfloor 82. As a result, film 50 acts as a vapor barrier substantially preventing moisture in subfloor 82 from reaching the finish flooring. Any residual moisture which may get past film 50 can rise into channels 78 and be directed along the channels until it is ultimately eliminated from the flooring system.

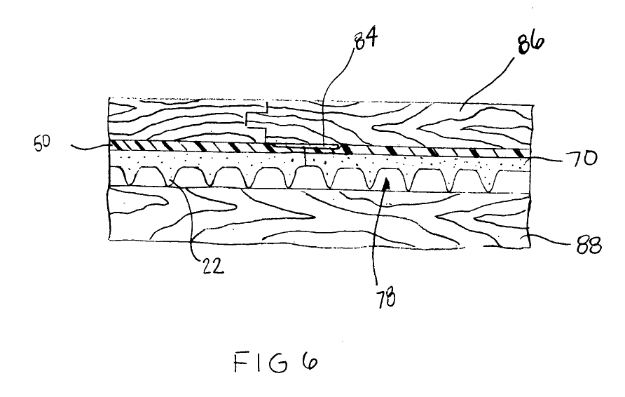

Another example of a flooring system in accordance with the present invention is shown in FIG. 6. In the illustrated flooring system, laminate 70 is installed between wood subfloor 88 and the planks 86 of wood laminate finish flooring. The flooring system in accordance with this arrangement is similar to that shown in FIG. 5. However, rather than orienting laminate 70 so that film 50 contacts the subfloor and ribs 22 face away from the subfloor, laminate 70 in this installation is oriented so that ribs 22 contact the wood subfloor 88 and film 50 faces away from the subfloor. The planks 86 of laminate wood flooring may be positioned on laminate 70 in a free-floating manner so that the planks rest on film 50.

In the foregoing installation, channels 78 confront subfloor 88, while film 50 serves as a vapor barrier between foam web 30 and planks 86. As a result, any moisture in subfloor 88 can rise into channels 78 and be directed along the channels until it is ultimately eliminated from the flooring system. The vapor barrier provided by film 50, however, prevents the moisture from attacking planks 86.

Certain features of the present invention as described above are illustrated in the following examples.

### EXAMPLE 1

A low density polyethylene resin having a melt index of 2 g/10 min and a density of 0.919 g/cm³ was combined in the feed zone of the primary extrusion chamber in a tandem extruder with 1.4 wt % of a nucleating agent masterbatch containing 50 wt % active talc and 50 wt % of the same low density polyethylene resin, and a 1.2 wt % of a permeation modifier mixture containing 66.7 wt % glycerol monostearate in 33.3 wt % monoethanolamide. The components were intricately fixed to form a homogenous polymer mixture. The mixture was then conveyed to the melt zone of the extruder and heated to a temperature of about 350° F. to form a molten mass. About 5.96 wt % (based on the weight of the resin) of an isobutane blowing agent was injected into the molten mass using a metering and pumping unit, and mixing continued until a homogenous blowing agent/polymer mixture was formed. This mixture was then conveyed to the secondary extrusion chamber in which it was cooled to a temperature of about 233.6° F. Once stabilized, the mixture was extruded through an annular die at a temperature of 233.6° F. to form a foam tube which, after expansion, had an outer diameter of about 19.02 inches and an inner diameter of about 18.716 inches. The foam tube was then conveyed under ambient conditions to a cutting station and slit longitudinally to form a corrugated foam sheet having a thickness of about 0.152 inches (including the height of the projecting ribs), a width of about 60 inches and a bulk density of about 2.4 lbs/ft³.

After a curing period, the corrugated foam web was heat laminated at a hot roller temperature of about 330° F. to a 2 mil high density polyethylene film using a standard heat lamination process.

### EXAMPLE 2

A low density polyethylene resin having a melt index of 1.5 g/10 min and a density of about 0.924 g/cm³ was combined in the feed zone of the primary extrusion chamber in a tandem extruder with 0.1 wt % of the same nucleating masterbatch used for Example 1, and 1.2 wt % of a permeation modifier mixture containing 66.7 wt % glycerol monostearate in 33.3 wt % monoethanolamide. The components were intricately mixed to form a homogenous polymer mixture. The mixture conveyed to the melt zone of the extruder and heated to a temperature of about 360° F. to form a molten mass. About 13.0 wt % (based on the weight of the resin) of a propane blowing agent was injected into the molten mass using a metering and pumping unit. Mixing of the ingredients continued until a homogenous blowing agent/polymer mixture was formed. This mixture was then conveyed to the secondary extrusion chamber of the extruder in which it was cooled to a temperature of about 234.5° F. Following stabilization, the mixture was extruded through an annular die at a temperature of about 234.4° F. to form a foam tube. After expansion, the foam had an outer diameter of about 19.58 inches and an inner diameter of about 19.05 inches. The expanded foam tube was then conveyed under ambient conditions to a cutting station and slit longitudinally to form a corrugated foam sheet having a thickness of about 0.265 inches (including the height of the projecting ribs), a width of about 60 inches and a bulk density of about 0.85 lbs/ft³.

Following a curing period, the corrugated foam web was heat laminated using conventional techniques at a hot roller temperature of about 330° F. to a 2 mil high density polyethylene film.

The above sample was tested before and after lamination to determine its moisture barrier property in accordance with the ASTM F1249-90 test method. The tests were conducted at 100° F. and 90% relative humidity. The test results in terms of moisture passage are shown in Table 1.

TABLE 1

| | Moisture Passage |
|---|---|
| Sample | (g/100 in²/day) |
| corrugated foam/no film | 1.47 |
| corrugated foam/2 mil | 0.23 |
| HDPE film | |

As shown in Table 1, corrugated foams having a high density film laminated thereto exhibit a significant improvement in their ability to act as a moisture barrier.

All numerical ranges recited herein include all subranges therebetween as if expressly set forth.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A floor underlayment material, comprising
a foam web including a polymer matrix and a multiplicity of voids dispersed throughout said polymer matrix, said foam web extending in a length direction and having first and second surfaces and a plurality of spaced ribs projecting from said first surface and oriented in said length direction; and
a film disposed on said second surface of said foam web.

2. The floor underlayment material as claimed in claim 1, wherein said film is formed from a polymer.

3. The floor underlayment material as claimed in claim 2, wherein said polymer is a polyolefin.

4. The floor underlayment material as claimed in claim 2, wherein said polymer matrix in said foam web is formed from substantially the same polymer as said film.

5. The floor underlayment material as claimed in claim 4, wherein said film is formed from polyethylene and said polymer matrix in said foam web is formed from polyethylene.

6. The floor underlayment material as claimed in claim 1, wherein said film has a thickness between about 0.25 mils and about 20 mils.

7. The floor underlayment material as claimed in claim 1, wherein said foam web has a density between about 0.5 lb/ft³ and about 15 lb/ft³.

8. The floor underlayment material as claimed in claim 7, wherein said foam web has a density of less than about 10 lb/ft³.

9. The floor underlayment material as claimed in claim 1, wherein said foam web is formed from low density polyethylene.

10. The floor underlayment material as claimed in claim 9, wherein said film is formed from high density polyethylene.

11. The floor underlayment material as claimed in claim 1, wherein said foam web has a predetermined thickness between said first and second surfaces, and said ribs project from said first surface by a height dimension, said height dimension being greater than said predetermined thickness.

12. The floor underlayment material as claimed in claim 11, wherein said height dimension is at least about twice as large as said predetermined thickness.

13. The floor underlayment material as claimed in claim 1, wherein said foam web has a thickness between said first and second surfaces of between about 0.01 inches and 1.50 inches.

14. The floor underlayment material as claimed in claim 11, wherein said foam web has an overall thickness including said predetermined thickness and said height dimension of between about 0.02 inches and about 4 inches.

15. The floor underlayment material as claimed in claim 1, wherein each of said ribs has a width at a junction with said first surface, and each of said ribs is separated from an adjacent one of said ribs by at least said width.

16. The floor underlayment material as claimed in claim 1, wherein said foam web includes at least one additive selected from the group consisting of antioxidants, colorants, anti-corrosion agents, anti-bacterial agents, anti-microbial agents, anti-fungal agents, anti-static agents, UV stabilizers, fire retardants, fire resistants, fillers, reinforcements, biostabilizers and pigments.

17. The floor underlayment material as claimed in claim 1, wherein said film includes at least one additive selected from the group consisting of antioxidants, anti-corrosion agents, anti-bacterial agents, anti-microbial agents, anti-fungal agents, anti-static agents, UV stabilizers, fire retardants, fire resistants and biostabilizers.

18. The floor underlayment material as claimed in claim 1, wherein said ribs have a generally triangular cross-sectional shape.

19. The floor underlayment material as claimed in claim 1, wherein at least a portion of said ribs extend continuously in said length direction, and at least another portion of said ribs are discontinuous.

20. The floor underlayment material as claimed in claim 1, further comprising another film disposed on free edges of said ribs.

21. The floor underlayment material as claimed in claim 20, wherein said another film is formed from high density polyethylene.

22. The floor underlayment material as claimed in claim 20, wherein said another film is formed from the same material as said film.

23. A flooring system, comprising
a subfloor;
finish flooring arranged above said subfloor; and
a floor underlayment material disposed between said subfloor and said finish flooring, said floor underlayment material including a foam web including a polymer matrix and a multiplicity of voids dispersed throughout said polymer matrix, said foam web extending in a length direction and having first and second surfaces and a plurality of spaced ribs projecting from said first surface and oriented in said length direction, and a film disposed on said second surface of said foam web.

24. The flooring system as claimed in claim 23, wherein said film is disposed adjacent said subfloor.

25. The flooring system as claimed in claim 24, wherein said floor underlayment material is oriented so that said ribs face toward said finish flooring, thereby defining a multiplicity of elongated channels between said finish flooring and said floor underlayment material.

26. The flooring system as claimed in claim 23, wherein said film is disposed adjacent said finish flooring.

27. The flooring system as claimed in claim 26, wherein said floor underlayment material is oriented so that said ribs face toward said subfloor, thereby defining a multiplicity of elongated channels between said subfloor and said floor underlayment material.
